(19) United States
(12) Patent Application Publication
(10) Pub. No.: US 2013/0293359 A1
(43) Pub. Date: Nov. 7, 2013

(54) AUTOMATIC DEVICE DETECTION BY REMOTE CONTROL

(71) Applicants: David Innes, Littleton, CO (US); Nathan Hale, Denver, CO (US)

(72) Inventors: David Innes, Littleton, CO (US); Nathan Hale, Denver, CO (US)

(73) Assignee: ECHOSTAR TECHNOLOGIES L.L.C., Englewood, CO (US)

(21) Appl. No.: 13/465,257

(22) Filed: May 7, 2012

(51) Int. Cl. G06K 7/01

(52) U.S. Cl. 340/10.5

(57) ABSTRACT

A system includes a remote control and a processing device. The processing device includes an RFID tag. An identification code is stored in the RFID tag. The remote control includes an RFID reader and a transmitter. The RFID reader transmits an interrogation signal. The RFID tag receives the interrogation signal and transmits the identification code in response to the interrogation signal. The RFID reader receives the identification code and the transmitter transmits control signals to control the processing device including a control code associated with the identification code.

### BACKGROUND

1. Technical Field

The present disclosure relates to the field of remotes controls used to control one or more processing devices.

2. Description of the Related Art

Remote controls are used in a large variety of applications. For example, remote controls are used to control televisions, set-top boxes, DVD players, stereo systems, gaming devices, garage doors, and a myriad of other applications. Oftentimes a single remote control is used to control multiple devices. In such cases, a user typically must manually press selected buttons first on the remote or enter a control code in order to use the remote control to control any given device. For example, a remote control that comes with a set-top box may often be programmed to control a television, a DVD player, a stereo system, or other electronic devices. However, to control such devices a user typically must manually input, in a particular sequence, a control code for each device to be controlled. This can be a cumbersome process, especially if the remote control runs out of batteries and it must be reprogrammed. Also, when a user of the remote exchanges an old device with a new device he must again enter a code in order to program the remote control to control the new device.

### BRIEF SUMMARY

One embodiment is a method of controlling a processing device. A control device transmits an interrogation signal from an RFID reader. One or more RFID tags, each coupled to a respective processing device, transmit an identification code in response to the interrogation signal. Each identification code identifies the processing device with which the respective RFID tag is associated. After receiving the identification codes the control device transmits control signals to the processing devices. The control signals include commands to be executed by the processing devices. The processing devices respond to the control signals when the proper code is included in the control signals.

In one embodiment the control signals include the identification code of the processing device to be controlled. In one embodiment the control signals include a control code associated with the identification code.

In one embodiment a remote control transmits the identification codes to a set top box. The set top box provides the control codes associated with the identification codes. The remote control then uses the control codes to control the processing devices.

One embodiment is a remote control that includes an RFID reader. The RFID reader transmits an interrogation signal and receives an identification code from an RFID tag associated with a processing device. The remote control utilizes the identification code to transmit control signals to the processing device in order to control the processing device. The RFID reader can receive identification codes from multiple RFID tags each associated with a respective processing device. The remote control can then control the processing devices as desired by a user.

### BRIEF DESCRIPTION OF THE SEVERAL VIEWS OF THE DRAWINGS

FIG. 1 is a block diagram of a system according to one embodiment.

FIG. 2 is an illustration of a system according to one embodiment.

FIG. 3 is a block diagram of a control device according to one embodiment.

FIG. 4 is a block diagram of a processing device according to one embodiment.

FIG. 5 is an RFID tag according to one embodiment.

FIG. 6 illustrates a method of controlling a processing device according to one embodiment.

FIG. 7 illustrates a method of controlling a processing device according to one embodiment.

### DETAILED DESCRIPTION

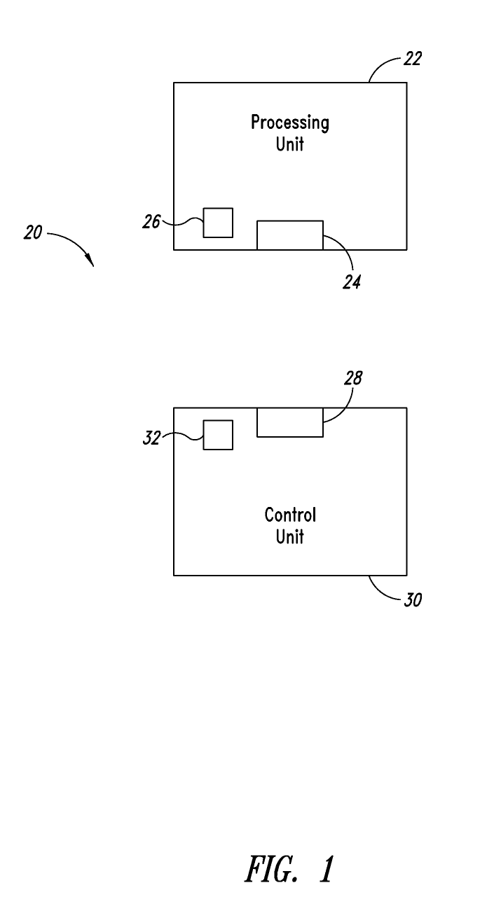

FIG. 1 is a block diagram of a remote control system 20 according to one embodiment. The system 20 includes a processing unit 22. The processing unit 22 includes a receiver 24 for receiving control signals and an RFID tag 26. The system further includes a control unit 30. The control unit 30 includes a transceiver 28 and an RFID reader 32.

The RFID reader 32 of the control unit 30 is configured to emit an RFID interrogation signal. The RFID tag 26 of the processing unit 22 receives the interrogation signal from the RFID reader 32 and in response transmits an identification code to the RFID reader 32. The identification code transmitted by the RFID tag 26 includes specific information about the processing unit 22. The identification code can include information identifying the type of device of processing unit 22, a particular make, model, and year of manufacture of the processing unit 22. In one example the processing unit 22 includes the tuner, receiver in channel selection circuitry of a D.T.U., Blu-Ray player, DVD player, radio, set-top box or similar entertainment system. The maker of the entertainment system, along with the particular model and control information of the processing information is provided. The identification code may also include a control code. The control code can be used to control the processing unit 22 by transmitting control signals to the receiver 24 of the processing unit 22.

The RFID reader 32 receives the identification code transmitted by the RFID tag 26 of the processing unit 22. The control unit 30 stores the identification code in memory. The control unit 30 can store all or a portion of the identification code received by the RFID reader 32. Using the identification code received from the RFID tag 26, the control unit 30 can now transmit control signals to the processing unit 22. The control signals can include a portion of the identification code from the RFID tag 26. The receiver 24 receives the control signals accompanied by the identification code and the processing unit 22 accepts the control signals and executes the commands within the control signals.

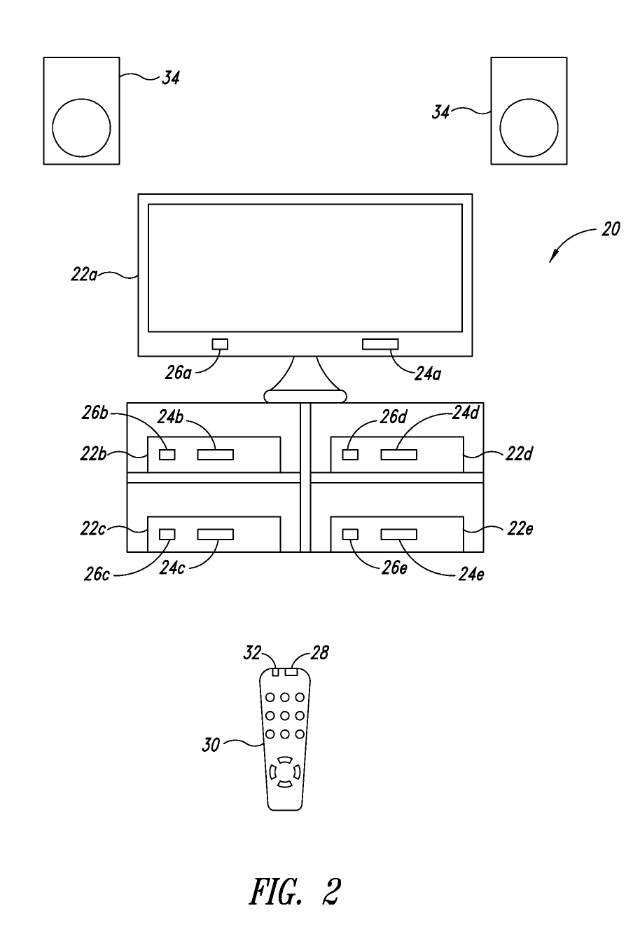

FIG. 2 illustrates a home entertainment system 20 according to one embodiment. The home entertainment system 20 includes a plurality of processing devices for example a television 22a, a set-top box 22b, a stereo system 22c, a DVD player 22d, and a game console 22e. The television, the set-top box, the stereo system, the DVD player, and the game console 22a-22e each includes a respective receiver 24a-24e and a respective RFID tag 26a-26e. The stereo system 22c controls speakers 34. The system 20 also includes a remote control 30. The remote control 30 includes a transceiver 28 and an RFID reader 32.

Each RFID tag 26a-26e includes an identification code identifying the processing device 22a-22e to which it is attached. The identification code can include information regarding the type of device, the manufacturer of the device, the particular model of the device, the year of manufacture of the device, and any other pertinent information. The RFID tag 24a of the television 22a can include an identification code that identifies that the television 22a was manufactured by a particular manufacturer, for example, Sony, Panasonic, LG, Sharp, or any other television manufacturer, as well as the particular model number and year of manufacture of the television 22a. It can also include other identification codes for the system it is coupled to, such as the particular processor inside the system, the version of software code inside the processor, the year it was made, the communication protocol for that processor or system and other information beneficial to the unique communication with the remote. The RFID tags 26b-26e of the other processing devices 22b-22e also include identification codes including the type of information described in relation to the identification code of the television 22a.

When the user of the system 20 desires to control any of the processing devices 22a-22e of the system 20, the user can input a command to the remote control 30. The remote control 30 then sends an interrogation signal from the RFID reader 32. The interrogation signal from the RFID reader 32 is received by each of the RFID tags 26a-26e of the processing devices 22a-22e. Each of the RFID tags 26a-26e responds to the interrogation signal by transmitting its respective identification code. The RFID reader 32 receives each of the identification codes. The remote control 30 then processes the identification codes received from the RFID tags 26a-26e and stores them in memory. The remote control 30 registers that there is a television 22a, a set-top box 22b, a stereo system 22c, a DVD player 22d, and a game console 22e within its range of control.

The remote control 30 can control the processing devices 22a-22e after the remote control 30 has obtained control codes for each of the devices 22a-22e. The control code for each device 22a-22e can be obtained based on the information received in the identification code from the respective RFID tags 26a-26e. In one embodiment, the remote control 30 stores in memory a database of control codes for each type of processing device 22a-22e according to the manufacturer and model number of each processing device 22a-22e. For example, the remote control 30 stores in its control code database a plurality of control codes for different kinds of televisions, set-top boxes, stereo systems, DVD players, game consoles, or other kinds of processing devices. In general, each model of television will have a particular control code associated with that model. A remote control 30 that is configured to control a television 22a will transmit control signals including the control code from the transceiver 28 to the television 22a. If the control signals include the correct control code, or are preceded by the control code, then the television 22a will execute the commands contained in the control commands. Commands sent with a faulty control code will not be executed properly, or may not be executed at all. Therefore, upon receiving the identification code from the RFID tag 26a of the television 22a, the remote control 30 can retrieve from the control code database the proper control code for the television 22a. The remote control 30 is then configured to control the television 22a. Likewise the remote control 30, upon receiving the identification codes from the RFID tags 26b-26e of the processing devices 22b-22e, can retrieve the proper control codes for each processing device 22b-22e from the control code database stored in the memory of the remote control 30. A user of the remote control 30 can select a particular device 22a-22e which he or she desires to control by pressing an appropriate selection button on the remote control 30. The remote control 30, having already obtained the proper control code for the selected device 22a-22e, can then control the selected device 22a-22e. The user can then switch between the various devices 22a-22e by inputting the appropriate selection to the remote control 30.

A user of the system 20 can therefore easily gain control of each of the processing devices 22a-22e by causing the remote control 30 to issue a single interrogation signal from the RFID reader 32. This can happen by pressing a single button on the remote control 30 a single time, or in any other suitable way by pressing one or more buttons. The user need not manually retrieve control codes for each of the processing devices 22a-22e and then enter them into the remote control 30 in order to control each of the processing devices 22a-22e as was done in past systems.

In one embodiment, the remote control 30 has been previously paired with the set-top box 22b. Thus, when the remote control 30 issues the interrogation signal from the RFID reader 32 and receives the identification codes from the RFID tags 26a and 26c-26e, the remote control can send the identification codes to the set-top box 22b. The set-top box 22b can store in memory a control code database like the control code database described as being stored in the remote control 30 previously. The set-top box 22b therefore receives the identification codes from the remote control 30 and retrieves from the control code database the control codes for the processing devices 22a and 22c-22e. The set-top box 22b transmits the control codes to the remote control 30. The remote control 30 stores in memory the control codes associated with the processing devices 22a and 22c-22e.

Alternatively, neither the remote control 32 nor the set-top box 22b contains a control code database stored in memory. Rather, upon receiving the identification codes from the RFID tags 26a and 26c-26e, the remote control 30 transmits the identification codes to the set-top box 22b and the set-top box 22b transmits the identification codes to a remote server or central database that contains a control code database. The server or central database transmits to the set-top box 22b the control codes associated with the identification codes stored in the RFID tags 26a and 26c-26e.

In one embodiment, the set-top box 22b contains a control code database stored in memory. The set-top box 22b, upon receiving the identification codes from the remote control 30, searches its control code database for the control codes associated with the identification codes. If the control codes are located, these are sent to the remote control 30. If the set-top box 22b cannot locate the appropriate control codes in the control code database, then the set-top box 22b can transmit the identification codes to the remote server or central database as described previously. The remote server or central database can then supply the proper control codes to the set-top box 22b. The set-top box 22b may update its control code database from time to time automatically, by requesting new control codes from the remote server or central database. The set-top box 22b can communicate with the remote server by a wired Internet access point or by wirelessly transmitting identification codes or an update request to a satellite with which it is in communication. The remote control 30 can obtain control codes to control the processing devices 22a-22e by any of the techniques described previously or by any other suitable techniques. Such other suitable techniques fall within the scope of the present disclosure.

In one embodiment, the transceiver 28 of the remote control 30 transmits the control commands in an RF frequency band. Processing devices such as the processing devices 22a-22e, which can be controlled by a remote control 30, commonly receive control signals in the RF frequency band. However, some processing devices may also receive control signals in other frequency bands. The transceiver 28 of the remote control 30 can be an RF transceiver, an infrared transceiver, or a transceiver utilizing any other suitable frequency band to transmit control signals to processing devices 22a-22e. The receivers 24a-24e of the processing devices 22a-22e can receive signals in an RF frequency band, or in an infrared frequency band, or in any other suitable frequency band.

The processing devices 22a-22e described in relation to FIG. 2 can include processing devices other than a television, a set-top box, a DVD player, a stereo system, or a game control console. Many types of electronic devices, and in particular consumer electronic devices, are controlled using remote controls. Any such device can be a processing device 22 according to principles of the present disclosure. All such other processing devices fall within the scope of the present disclosure.

In one embodiment, the identification codes stored by the RFID tags 26a-26e include the control codes for the devices 22a-22e. The remote control 30, upon receiving the identification codes from the processing devices 22a-22e, can extract from the identification codes the control codes associated with the the processing devices 22a-22e. The remote control 30 can then issue control signals to the respective processing devices 22a-22e, including the proper control codes. The identification code may be encrypted or contain a hash that includes the control code.

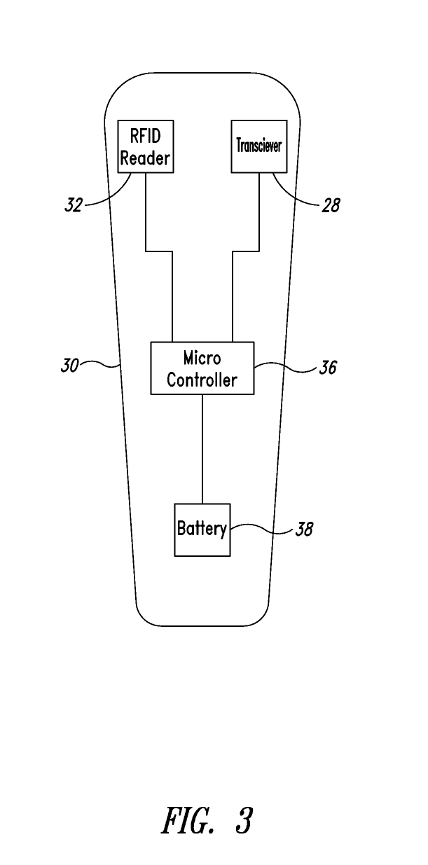

FIG. 3 is block diagram of a remote control 30 according to one embodiment. The remote control 30 includes a transceiver 28, an RFID reader 32, a microcontroller 36, and a battery 38. The RFID reader 32 and the transceiver 28 are coupled to the microcontroller 36. The microcontroller 36 controls the RFID reader 32 and the transceiver 28. The microcontroller 36 can cause the RFID reader 32 to emit the interrogation signal as described previously. In response to the interrogation signal, the RFID reader 32 receives an identification code from an RFID tag 26 as described previously. The microcontroller 36 receives the identification code or codes from the RFID reader 32. The microcontroller 36 processes the identification codes and stores them in memory. The memory can be included in the microcontroller 36 or a memory circuit can be provided separately in the remote control 30 and coupled to the microcontroller 36. In an embodiment in which the remote control 30 contains a control code database stored in the memory of the microcontroller 36, the microcontroller 36 can retrieve the control codes associated with the identification codes received from the RFID reader 32. In response to a user input the microcontroller 36 then causes the transceiver 28 to transmit control signals to the processing device 22. The control signals include the control code associated with the identification code. The control signals including the proper control code can cause the processing device 22 to execute the commands contained in the control signals. In an embodiment in which a control code database is not stored in the remote control 30, the microcontroller 36 can cause the transceiver 28 to transmit the identification code to a set-top box or other processing device which contains a control code database or which can retrieve the control codes from a control code database stored on a server or other central database. The transceiver 28 can receive the control codes from the set-top box or other processing device and the control codes can be processed and stored by the microcontroller 36. When a user of the remote control 30 inputs commands to the remote control, the microcontroller 36 processes those commands and executes them. Therefore, when a user picks up the remote control 30 and gives an input indicating that an interrogation signal should be sent from the RFID reader 32, the microcontroller 36 processes the user input and causes the RFID reader 32 to emit the interrogation signal. The microcontroller 36 also receives other user inputs, such as which processing device 22 should be controlled and what control signals should be sent to the processing device 22. The battery 38 powers the microcontroller 36 and any other components of the remote control 30. Alternatively, the remote control 30 may be connected to a power source other than a battery 38.

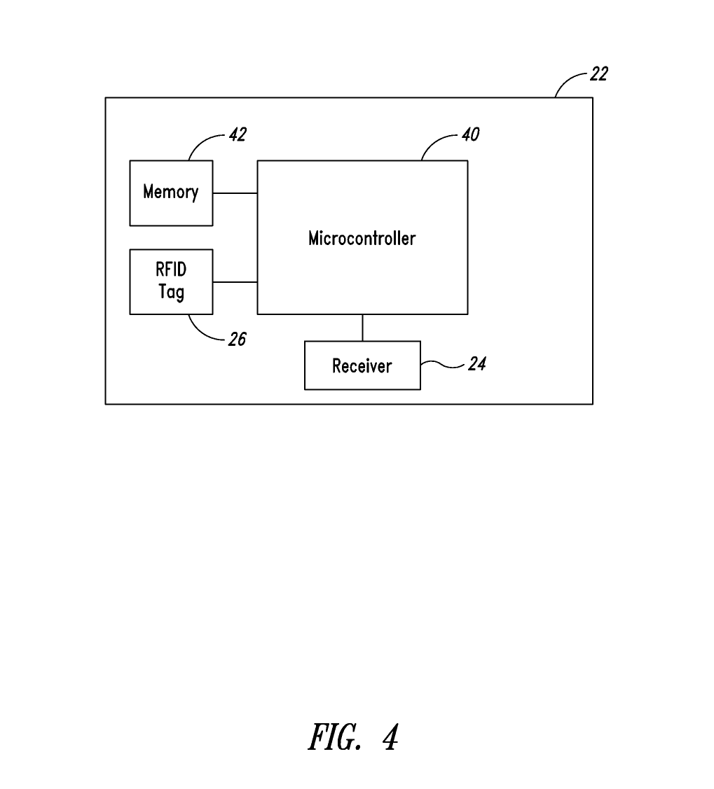

FIG. 4 is a block diagram of a processing device 22 according to one embodiment. The processing device 22 includes a microcontroller 40, an RFID tag 26 coupled to the microcontroller 40, a transceiver 24 coupled to the microcontroller 40, and a memory 42 coupled to the microcontroller 40. The RFID tag 26 stores in a memory of the RFID tag 26 an identification code identifying the manufacturer, model number, year of manufacture, or any other suitable information regarding the processing device 22 to which it is attached, as previously indicated. Upon receiving an interrogation signal from a remote control 30 as described previously, the RFID tag 26 transmits the identification code. The remote control 30 then obtains the control code associated with the identification code by any suitable technique as described previously. The receiver 24 then receives control signals from the remote control 30. The receiver 24 provides the control signals to the microcontroller 40. The microcontroller 40 checks to see that the control signals include the proper control code. If the control signals include the proper control code, then the microcontroller 40 executes the commands contained within the control signals. The microcontroller 40 can reference the memory 42 to determine if the control code received in the control signals is the proper control code.

In one embodiment, a processing device 22 is a set-top box previously paired to a remote control 30. The receiver 24 of the processing device 22, receives a signal from the remote control 30 including one or more identification codes obtained from RFID tags 26a and 26c-26e associated with other processing devices 22a and 22c-22e as described previously. The microcontroller 40 receives the identification codes from the receiver 24 and, in one embodiment, retrieves from a control code database stored in the memory 42 the proper control codes associated with the identification codes received from the remote control 30. The microcontroller 40 then causes the receiver 24 which, in such an embodiment, is a transceiver to transmit the control codes associated with the identification codes to the remote control 30. The remote control 30 can then control the other processing devices as described previously. Alternatively, the microcontroller 40 transmits to a remote server or central database a request for the control codes associated with the identification codes received from the remote control 30. The microcontroller 40 causes the receiver 24 to transmit to the remote control 30 the control codes received from the remote server or central database. Alternatively, the memory 42 can include a control code database as described previously. The microcontroller 40 can request from the remote server or central database periodic updates to the control code database stored in the memory 42.

The RFID tag 26 shown in FIG. 4 is an active RFID tag. The RFID tag 26 receives power from the microcontroller 40. Alternatively, the RFID tag 26 can be a passive RFID tag which is not electrically connected to the microcontroller 40. Such a passive RFID tag can receive power from the interrogation signal received from the RFID reader 32 of the remote control 30 in a known manner. Alternatively, the RFID tag 26 includes a battery and is powered thereby.

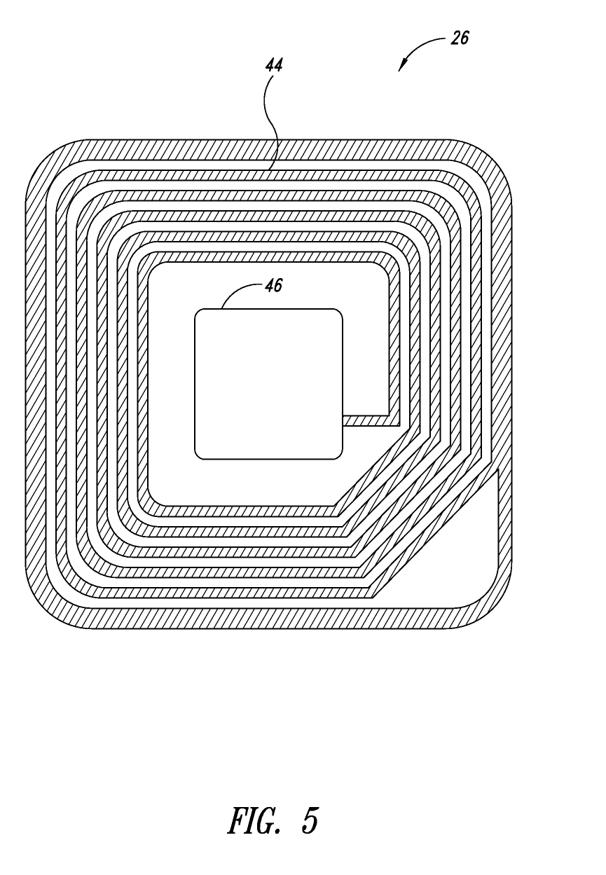

FIG. 5 illustrates an RFID tag 26 according to one embodiment. The RFID tag 26 includes an antenna coil 44 and an integrated circuit chip 46. The antenna coil 44 is electrically coupled to the integrated circuit chip 46. When the RFID reader 32 emits the interrogation signal, the antenna coil 44 of the RFID tag 26 receives the interrogation signal and is energized thereby. The integrated circuit chip 46 receives the interrogation signal from the antenna coil 44. The integrated circuit chip 46 includes an internal memory in which is stored the identification code described previously. In response to receiving the interrogation signal, the integrated circuit chip 46 causes the antenna coil 44 to transmit the identification code stored in the memory of the integrated circuit chip 46. The antenna coil 44 therefore radiates the identification code which can be received by the RFID reader of the remote control 30. The RFID tag 26 can include a battery powering the RFID tag 26. Or the RFID tag 26 can be a passive RFID tag in which the energy to transmit the identification code is taken from the energy of the interrogation signal received by the antenna coil 44.

The antenna coil 44 is a conductive coil which is energized by receiving signals in a particular frequency band. After being energized by receiving a signal in the particular frequency band, the antenna coil 44 then radiates energy in the same frequency band or in a different frequency band according to the design of the RFID tag 26. The RFID tag 26 can be produced by any conventional method for making an RFID tag. Such methods for manufacturing an RFID tag are well known in the art and will not be described here.

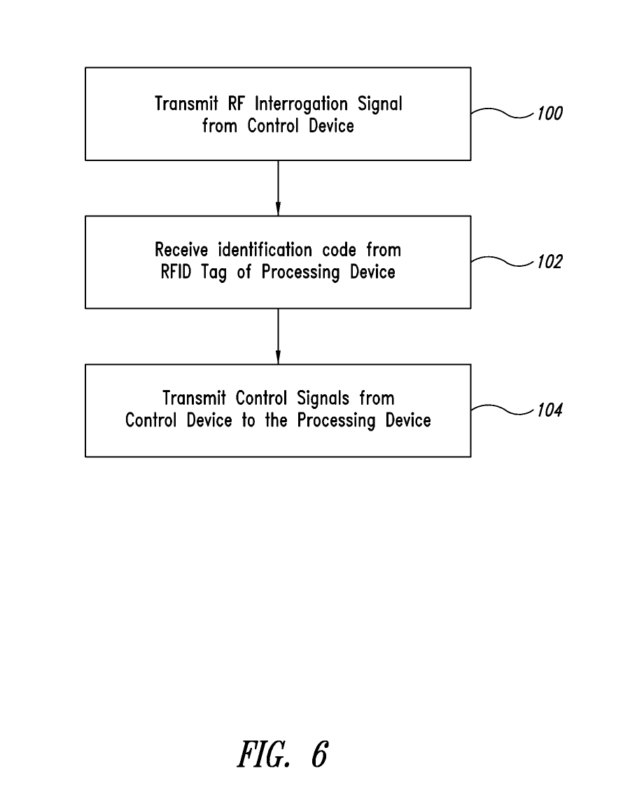

FIG. 6 illustrates a method for controlling a processing device 22 by a control device 30 according to one embodiment. At 100, the control device 30 transmits an RF interrogation signal. At 102, the control device receives an identification code from an RFID tag 26 coupled to the processing device 22. At 104, the control device 30 transmits control signals to the processing device 22 to control the processing device 22. The control signals include a control code associated with the identification code received from the RFID tag 26. The processing device 22 executes the commands in the control signals containing the proper control code.

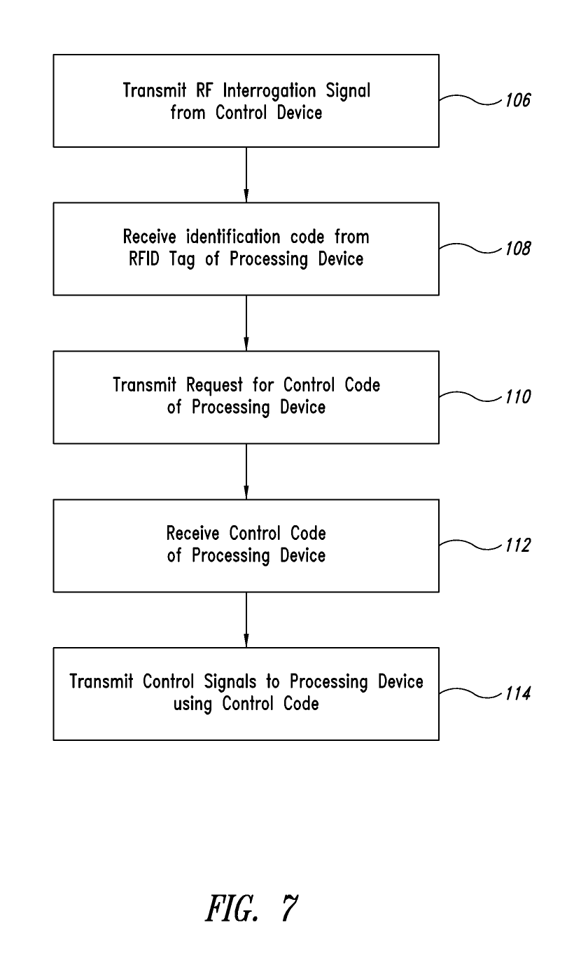

FIG. 7 illustrates a method of controlling a processing device 22a by a control device 30 according to one embodiment. At 106, the control device 30 transmits an RF interrogation signal from an RFID reader 32 of the control device 30. An RFID tag 26 coupled to the processing device 22a receives the interrogation signal from the RFID reader 32 and in response to the interrogation signal transmits an identification code. The identification code contains information regarding the make, the model, and the year of the processing device 22a.

At 108, the RFID reader 32 of the control device 30 receives the identification code from the RFID tag 26 of the processing device 22a. At 110, the control device 30 transmits a request for the control code associated with the identification code of the processing device 22a. The request is received by a second processing device 22b which then retrieves the control code from a database or from a remote server or central database. The second processing device 22b then transmits the control code associated with the identification code to the control device 30.

At 112, the control device 30 receives the control code associated with the identification code from the processing device 22b. At 114, the control device 30 transmits control signals to the first processing device 22a, including the control code. The first processing device 22a executes the commands contained in the control signals because the control signals include the proper control code.

While the present disclosure describes particular processing devices 22, and components of the processing devices 22, and of the control device 30, other suitable embodiments can be used instead of those particular alternatives described herein. All such suitable alternatives, including different components of the processing devices 22 and the control device 30, as well as different techniques for obtaining a control code or transmitting control signals, including a control code, the identification code, or a component of the control code or identification code, can be used. All such techniques, components, and structures fall within the scope of the present disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
transmitting an interrogation signal from an RFID reader in a remote control;
receiving in the RFID reader a first identification code from a first RFID tag coupled to a first media entertainment system;
storing the identification code in a memory in the remote control;
transmitting first control signals from the remote control to the first media entertainment system to control the first media entertainment system, the first control signals including a first control code associated with the first identification code to enable the control signals to control the first media entertainment system;
receiving, in the RFID reader, a second identification code from a second RFID tag coupled to a second media entertainment system in response to the interrogation signal; and
transmitting second control signals from the remote control to the second media entertainment system to control the second media entertainment system, the second control signals including a second control code associated with the second identification code to enable the second control signals to control the second media entertainment system.

2. The method of claim 1 wherein the first and second identification codes identify respective device categories of the first and second media entertainment systems.

3. The method of claim 2, comprising:
receiving a category selection input in the remote control; and
transmitting the first or the second control signals based on the category selection input.

4. The method of claim 1, comprising:
transmitting the first identification code from the remote control to a second media entertainment system; and
transmitting the first control code from the second media entertainment system to the remote control.

5. The method of claim 4 wherein the first control code is stored in a control code database in a memory of the second media entertainment system.

6. The method of claim 4, comprising:
receiving the first identification code in the second media entertainment system from the remote control;
transmitting a first control code request from the second media entertainment system to a control code database;
receiving the first control code in the second media entertainment system from the control code database; and
transmitting the first control code from the second media entertainment system to the remote control.

7. The method of claim 4 wherein the second media entertainment system is a set top box.

8. The method of claim 1 wherein the first media entertainment system is one of a TV, a computer, a gaming console, a video media entertainment system, a set top box, or a stereo system.

9. The method of claim 1 comprising transmitting the first control code from the first RFID tag to the RFID reader.

10. A device, comprising:
an RFID reader configured to transmit an RFID interrogation signal and to receive a first identification code from a first processing device in response to the interrogation signal;
a memory coupled to the RFID reader and configured to store the first identification code; and
a transmitter coupled to the memory and configured to transmit first control signals to control the first processing device, the first control signals including a first control code associated with the first identification code.

11. The device of claim 10 wherein the RFID reader is configured to receive a second identification code from a second processing device, the memory being configured to store the second identification code, the transmitter being configured to transmit second control signals to control the second processing device, the second control signals including a second control code associated with the second identification code.

12. The device of claim 11, comprising:
a microcontroller coupled to and configured to control the transmitter, the memory, and the RFID reader; and
an input coupled to the microcontroller, the input configured to receive a device category selection signal, the microcontroller configured to cause the transmitter to transmit the first or second control signals based on the device category selection signal.

13. A device, comprising:
a microcontroller;
a receiver coupled to the microcontroller, the receiver configured to receive control signals including a control code, the microcontroller configured to execute the control signals upon receiving the control code; and
an RFID tag including a memory, the control code being stored in the memory.

14. The device of claim 13 wherein the RFID tag is configured to transmit the control code to an RFID reader upon receiving an interrogation signal from the RFID reader.

15. The device of claim 13 wherein the RFID tag is an active RFID tag.

16. The device of claim 13 wherein the RFID tag is electrically coupled to the microcontroller.

17. The device of claim 13 wherein the RFID tag is a passive RFID tag.
